(19) United States
(12) Patent Application Publication
(10) Pub. No.: US 2011/0155404 A1
(43) Pub. Date: Jun. 30, 2011

(54) HAND-HELD ELECTRIC TOOL

(75) Inventor: Changxi Dai, Nanjing (CN)

(73) Assignee: CHERVON LIMITED, Wanchai (HK)

(21) Appl. No.: 12/971,673

(22) Filed: Dec. 17, 2010

(30) Foreign Application Priority Data
Dec. 30, 2009 (CN) 200920283188.X

(51) Int. Cl. B25D 11/00

(52) U.S. Cl. 173/117

(57) ABSTRACT

A hand-held electric tool having a housing, a machine core, and a working head disposed on the housing is further provided with a manual hammer component. The manual hammer component is usable to manually strike an object, such as a nail. The working head is disposed at one side of the front end of the housing and the manual hammer component is disposed at the other side of the front end of the housing and opposite to the working head.

### RELATED APPLICATION INFORMATION

This application claims the benefit of CN 200920283188.X, filed on Dec. 30, 2009, the disclosure of which is incorporated herein by reference in its entirety.

### BACKGROUND

This application relates to electric tools and, more particularly, to hand-held electric tools.

Hand-held electric tools are widely used in the fields of construction, furniture making, home decorating, etc. However, in some cases, know hand-held electric tools may not be effective in meeting the end needs of user. For example, when the battery package of a hand-held electric tool runs out of power, or the tool can not be operated due to some fault, any work that is currently being performed by a user, such as the striking of nails, cannot be completed utilizing such tool.

### SUMMARY

The subject disclosure is directed to a hand-held electric tool, such as an electric nailer, having a manually operable hammer component. As such, the hand-held electric tool may be used to manually strike nails even when the electric nailing component thereof can not be operated. While described in the context of an electric nailer, the manual hammer component could also be attached to other electric tools, such as the electric drill, so as to achieve the function for striking nails.

To this end, the subject disclosure describes a hand-held electric tool which comprises a housing, a machine core and a working head disposed on the housing wherein a manual hammer component is disposed on the housing. The working head is disposed at one side of the front end of the housing and the manual hammer component is disposed at the other side of the front end of the housing, which is opposite to the working head. A tool that is conveniently used and which has multiple functions is thus described.

### BRIEF DESCRIPTION OF THE DRAWINGS

FIG. 1 is a schematic view showing the structure of the hand-held electric tool according to the invention; and

FIG. 2 is a sectional view taken along A-A in FIG. 1.

### DETAIL DESCRIPTION

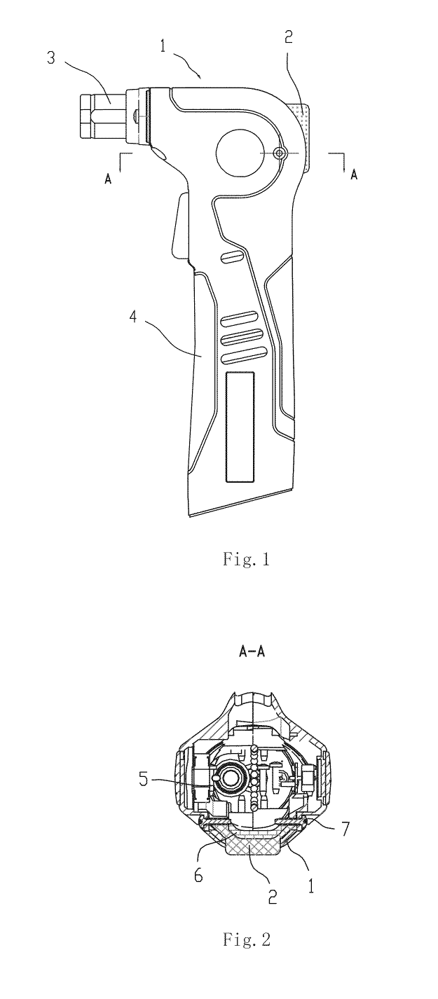

Preferred embodiments will now be described in detail with reference to the accompanying drawings wherein FIGS. 1 and 2 are a schematic view showing the structure of an exemplary hand-held electric tool and a sectional view taken along A-A of FIG. 1, respectively. A preferred embodiment of the hand-held electric tool is an electric nailer which could also be used to manually strike nails. The hand-held electric tool comprises a housing 1, a machine core 5, a striking working head 3 disposed at one side of the front end of the housing and perpendicular to a handle 4 of the housing, and a manual hammer component 2 adapted for manual operations disposed at the other side of the front end of the housing and opposite to the striking working head 3. The manual hammer component 2 is formed using gray iron materials or the like. The interior end portion of the manual hammer component 2 is abutted against the gear shell 6. Alternatively, a buffer cushion can be further added between the manual hammer component 2 and the gear shell 6. The exterior end portion of the manual hammer component 2 is exposed out of the housing 1, and the manual hammer component 2 is connected and fixed to the housing 1 by fixing screws 7 or the like. Alternatively, the manual hammer component 2 can be an insert which is molded together with the housing 1 when the housing is molded.

While illustrated and described in the context of an electric nailer, it will be understood that a manual hammer component 2 could also be provided on other hand-held electric tools, such as electric drills or the like, in a similar manner. As will also be appreciated, when the manual hammer component 2 is added onto a hand-held electric tool, such as an electric drill, such drill-type tools can thus be provided with the ability to striking nails as well as to strike screws.

What is claimed is:

1. A hand-held electric tool, comprising a housing, a machine core, and a working head disposed on the housing, wherein a manual hammer component for use in manually striking nails is disposed on said housing.

2. The hand-held electric tool according to claim 1, wherein the working head is disposed at one side of a front end of the housing.

3. The hand-held electric tool according to claim 2, wherein the manual hammer component is disposed at the other side of the front end of the housing and opposite to the working head.

4. The hand-held electric tool according to claim 1, wherein the hand-held electric tool is an electric nailer.

5. The hand-held electric tool according to claim 1, wherein the manual hammer component is formed using gray iron materials.

6. The hand-held electric tool according to claim 1, wherein the manual hammer component is connected and fixed to the housing by fixing screws.
